(19) United States
(12) Patent Application Publication
(10) Pub. No.: US 2013/0134347 A1
(43) Pub. Date: May 30, 2013

(54) Composite Structures with Phase Change Material and Adsorbent and Encapsulant Materials

(71) Applicants: Michael Hugh Edgar, Tuscaloosa, AL (US); William Rusty Sutterlin, Tuscaloosa, AL (US)

(72) Inventors: Michael Hugh Edgar, Tuscaloosa, AL (US); William Rusty Sutterlin, Tuscaloosa, AL (US)

(21) Appl. No.: 13/462,743

(22) Filed: May 2, 2012

Related U.S. Application Data
(60) Provisional application No. 61/481,709, filed on May 2, 2011.

(51) Int. Cl. C09K 5/14

(52) U.S. Cl. CPC C09K 5/14
USPC 252/62; 264/241; 427/160

(57) ABSTRACT

A composite structure providing heat storage capability and including a phase change material (PCM), adsorbent material and encapsulant material. The encapsulate material surrounds the PCM and adsorbent. The phase change material and adsorbent material and encapsulant material can be provided in a mixture which is subsequently formed into a structural panel. The composite structure may be used to provide passive thermal control. A method of making composite structures having PCM, adsorbent material and encapsulant materials is also provided.

### RELATED APPLICATIONS

This application claims the benefit of priority of U.S. Ser. No. 61/481,709, filed May 2, 2011, which is hereby incorporated by reference in its entirety.

### TECHNICAL FIELD

The present invention relates to composite structures and more particularly to structures providing heat storage capability by incorporating a phase change material (PCM).

### BACKGROUND OF THE INVENTION

A phase change material (PCM) is a substance with a high heat of fusion which, upon melting and solidifying at certain temperatures, is capable of storing or releasing large amounts of energy. Initially, solid-liquid PCMs perform somewhat like conventional storage materials: their temperature rises as they absorb heat. Unlike conventional storage materials, however, when such PCMs reach their phase change temperatures (i.e., melting point temperature) they absorb large amounts of heat without a significant rise in temperature. When the ambient temperature around a liquid material falls, the PCM solidifies, releasing its stored latent heat. Certain PCMs store 5 to 14 times more heat per unit volume than conventional storage materials such as iron, masonry, or rock. This property can be harnessed to regulate the temperature of an environment or object for an extended time. The use of ice as a thermal storage material for food is an example of this principle. Water is charged by freezing to remove energy from the water and form ice. As heat energy is transferred to the ice, such as by placing the ice in a warm liquid, each unit of heat energy transferred to the ice is absorbed by the water molecules. Not until sufficient energy has been transferred to the water molecules is the ice able to melt. The temperature of the ice stays constant until the phase change from solid to liquid is complete. The melted ice, or water, then increases in temperature as more energy is transferred to the water.

In many PCMs, the phase changes are reversible so that the latent heat storage can be used for either heating or cooling. That is, the PCMs release energy as the material changes from a liquid to a solid. Thus, the latent heat stored or released during the phase change can be used for cooling or heating, depending on how the PCM is charged and the temperature of the surrounding environment.

PCMs can be broadly grouped into two categories: “Organic Compounds” (such as polyethylene glycol) and “Salt-based Products” (such as Glauber's salt). The most commonly used PCMs are salt hydrides, fatty acids and esters, and various paraffins (such as octadecane). Ionic liquids have also been investigated as novel PCMs.

### SUMMARY OF THE INVENTION

The present invention is directed to structures comprising a mix of phase change materials, adsorbent and encapsulant materials. A structure in accordance with the present invention may be used as a building construction material. The structure can be used in heat storage applications where thermal regulation characteristics are desired. Structures in accordance with the present invention would find wide applicability including, but not limited to, food packaging, primary packaging for life science articles, serving ware, automotive panels, heat condensers and other HVAC related structures, wall boards and furniture.

A panel is one type of structure in accordance with the present invention. The panel includes a PCM mixed with an adsorbent and an encapsulant. Panels made in accordance with the present invention provide passive thermal storage. The PCM component provides for high storage of thermal energy and can be designed to fit a wide range of climates or environments. The encapsulant and adsorbent components of the panel provide rigidity and strength to the structure. This allows the panels to be designed into numerous sizes which can later be cut for specific fit or secured without the worry of a liquid PCM leaking out from the panels.

Inexpensive materials may be used in accordance with the present invention. Accordingly, an object and advantage of the present invention is to provide panels which are a very affordable option for lowering the energy costs of a home or building. The present invention is also very versatile, so it can be used in any application where cheap thermal management is needed. In some embodiments, the plastic nature of a composite in accordance with the present invention allows for custom design of any shape. In preferred embodiments, the materials used to make the panels are lightweight and sturdy. The panels may even be incorporated into existing structures.

In another embodiment of the present invention, the structures are coated with a material to provide additional protection to the structure. The coating may be sprayed, laminated, dipped, painted or otherwise applied using commonly known coating application technologies. The coating would prevent the PCM from leaching out of the panel. The coating could also provide UV protection, thermal conductivity enhancement, flame retardancy. For certain food-related structures of the present invention, the coating may be of a food grade material.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of a molded panel embodiment of the present invention.

FIG. 2 is a cross-sectional view of the panel of FIG. 1.

FIG. 3 is a DSC (differential scanning calorimetry) graph of a first panel embodiment.

FIG. 4 is a DSC (differential scanning calorimetry) graph of a second panel embodiment.

FIG. 5 is a DSC (differential scanning calorimetry) graph of a third panel embodiment.

FIG. 6 is a DSC (differential scanning calorimetry) graph of a fourth panel embodiment.

### DETAILED DESCRIPTION OF THE INVENTION

The present invention provides a structure comprising a mixture of a phase change material (PCM) and adsorbent materials. An encapsulant surrounds the adsorbent and PCM, encapsulating them. Adsorbents that may be used in accordance with the present invention include, but are not limited to, activated carbon, diatomaceous earth powder, cellulose, fibers, foams, meshes, silica, cellite, gypsum, zeolite, cork, wood pulp, graphite, corn stover, cellulosic biomass and other porous materials. PCM's that may be used in accordance with the present invention include, but are not limited to, derivatives of fatty acids and paraffins, polyethylene glycols, salts and salt hydrates. For example, PCM's that may be used include a variety of commercially available PCM powders. Encapsulants that may be used in accordance with the present invention include, but are not limited to, polymers such as polyethylene, polypropylene, polyethylene terephthalate, acrylic polymer gels, and polyurethane. Once the mixture is prepared it is processed to fit the application. For example, the mixture may be molded into a panel or other form. A variety of molding technologies could be utilized to form structures of the present invention utilizing the PCM/adsorbent/encapsulant materials. In some embodiments, a liner may be used to sandwich the mixture in order to strengthen it and prevent it from splitting, and to reduce flammability.

Without the adsorbent the encapsulant would inhibit the phase change of the PCM, reducing the latent heat that the panel would exhibit. Therefore, an adsorbent is used so the phase change can occur in the adsorbent without being hindered. The adsorbent cannot contain the PCM entirely while it is in its liquid phase, so the encapsulant is used to encapsulate both PCM and adsorbent materials. A significant feature of the invention is the structure rigidity provided by the mixture of materials coupled with the efficiency of the incorporated PCM.

Careful selection of the relative amounts of PCM, adsorbent, and encapsulant used in the mixture is required in order to maintain a balance between thermal performance and structural integrity. For example, a higher thermal performance is achieved when a greater level of PCM and a lower level of encapsulant is included in the mixture, but the lower level of encapsulant leads to the formation of a weaker panel.

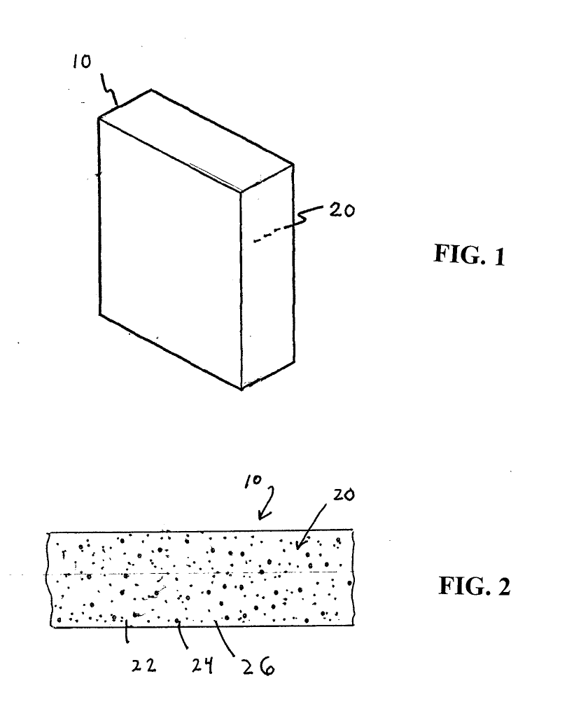

FIG. 1 illustrates a molded, generally rectangular, panel 10 incorporating a mixture 20 including PCM, adsorbent and encapsulant materials. The panel is shown as one embodiment of the present invention. Alternative embodiments would present structures of different shapes, sizes, dimensions, etc.

FIG. 2 is a cross-sectional view of panel 10 showing a phase change material 22, adsorbent 24 and encapsulant material 26.

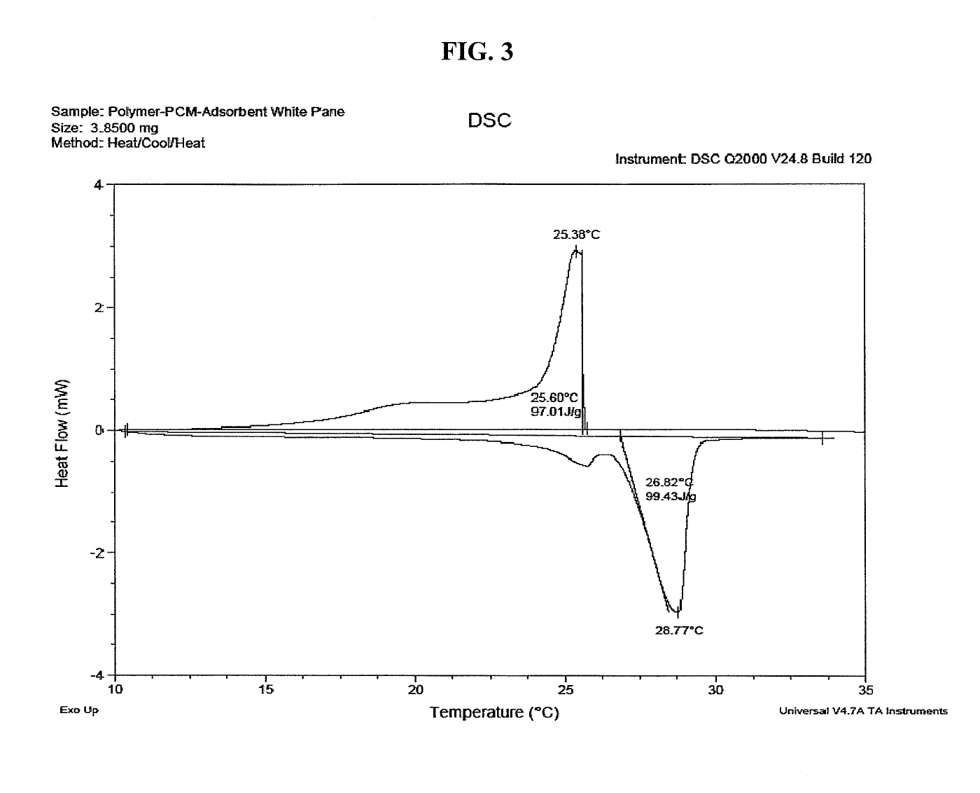

As an experiment, four different panels 10 were prepared and compared. Differential scanning calorimetry (DSC) graphs of the four panels are shown in FIGS. 3-6. Two different adsorbents and two different PCM's were used to prepare the four panels 10. The original latent heat of both PCM's is approximately 200 J/g. The DSC graphs of the panels show 40 to 50% efficiency.

Specifically, to prepare a first panel 10, diatomaceous earth powder was used as the adsorbent, and PT 28, which is commercially available from Entropy Solutions, Inc., of Plymouth, Minn., United States, was used as the PCM. The DSC graph of this panel is shown in FIG. 3.

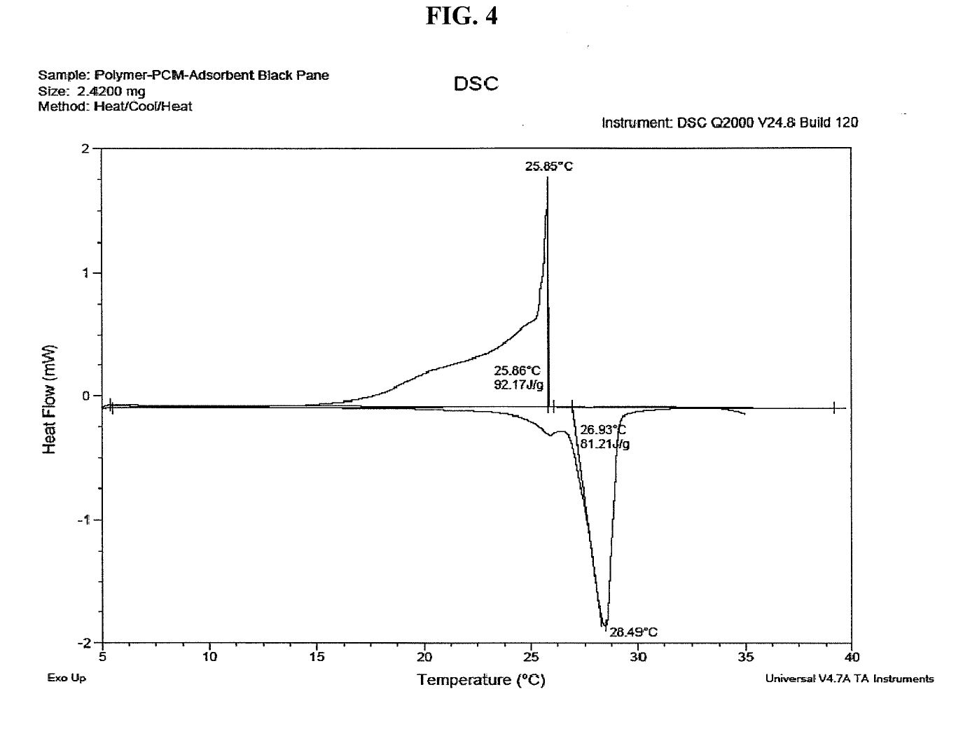

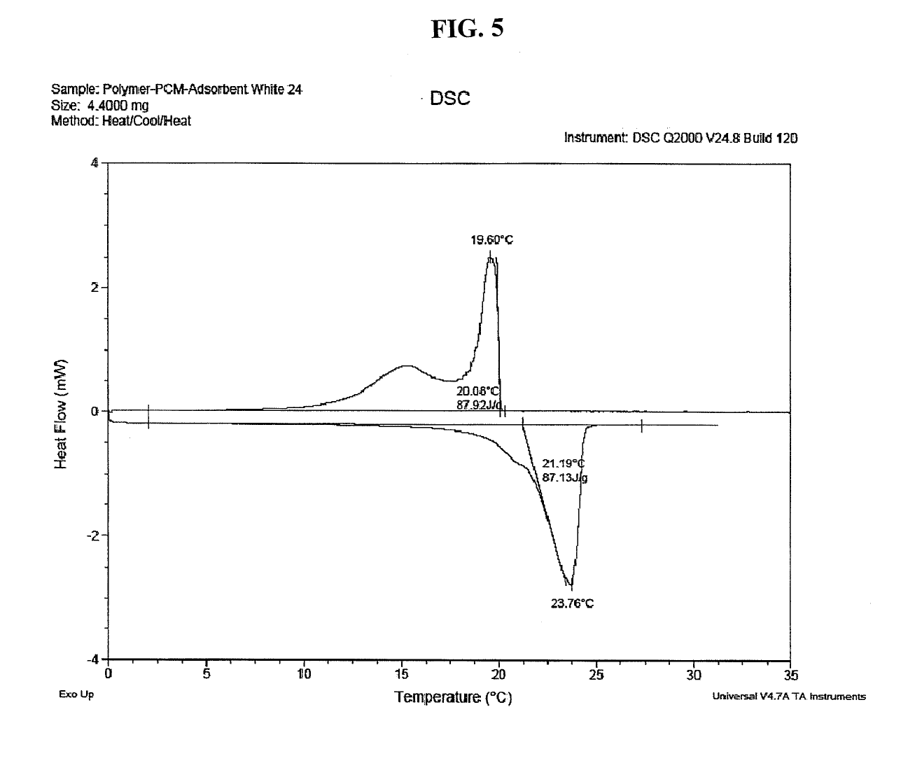

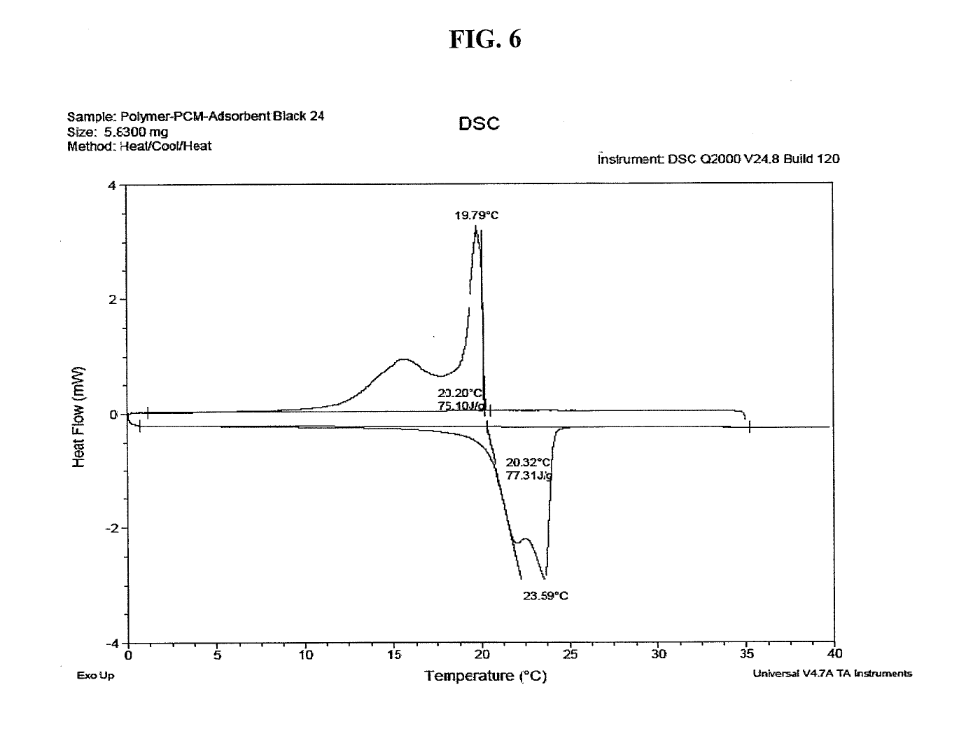

To prepare a second panel 10, activated carbon was used as the adsorbent, and PT 28 was used as the PCM. The DSC graph of this panel is shown in FIG. 4. To prepare a third panel 10, diatomaceous earth powder was used as the adsorbent, and PT 24, which is available from Entropy Solutions, Inc., was used as the PCM. The DSC graph of this panel is shown in FIG. 5. To prepare a fourth panel 10, activated carbon was used as the adsorbent, and PT 24 was used as the PCM. The DSC graph of this panel is shown in FIG. 6.

The preparation of first panel 10 is described below. Similar processes were used to prepare the other panels 10. The first panel 10 was constructed by first taking diatomaceous earth (DE powder) and drying it in a convection oven at 200° C. This removed moisture from its pores. Then 110.8 grams of PCM was measured out and placed into a beaker. In this example, the PCM used was PT 28, which is available from Entropy Solutions, Inc., of Plymouth, Minn., United States. Then 66.7 grams of the dry DE powder was weighed and placed into the beaker with the PT 28. The contents of the beaker were then mixed thoroughly with a spatula and a vortex. Once the mixture was homogenous the beaker was placed in a second convection oven at 60° C. A second beaker was then filled with 44.6 grams of high density polyethylene (HDPE). This beaker was then put in the first convection oven and heated to 200° C. Once the HDPE was completely melted the beaker with the PT 28 and DE powder was scooped into the beaker with the HDPE with a wooden spoon, and the three components were thoroughly mixed until the mixture appeared homogenous. The mixture was then allowed to cool and then was placed into a 18 cm by 18 cm teflon coated pan. The pan was then placed back into the oven and heated at 200° C. until the composite melted and settled. This heating step was mainly carried out in order to reshape the composite. Alternatively, the mixture could be placed in a mold after the mixture was obtained. After heating at 200° C., the pan was then removed and allowed to cool. After the composite was cooled the hardened composite panel was removed. The resulting composite was approximately 50% PT 28, 30% DE powder, and 20% HDPE.

Composite structures made in accordance with the present invention may be used in a variety of applications in which passive thermal management is desired, including, but not limited to, floor panels, ceiling tiles, wall boards, attic liner, exterior panels, and door panels. The composite structures may be used in both residential and commercial buildings. Other uses of composite structures of the present invention include primary packaging for the food industry, primary packaging for life science industry, food serving ware and implements, automotive panels, heat condensers and other HVAC components, and furniture.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A composite structure comprising:
a phase change material mixed with an adsorbent material; and
an encapsulant material which encapsulates the mixture of phase change material and adsorbent material.

2. The composite structure of claim 1, wherein the phase change material is selected from the group consisting of derivatives of fatty acids and paraffin, polyethylene glycols, salts and salt hydrates.

3. The composite structure of claim 1, wherein the adsorbent material is selected from the group consisting of activated carbon, diatomaceous earth powder, cellulose, fibers, foams, meshes, silica, cellite, gypsum, zeolite, cork, wood pulp, and graphite.

4. The composite structure of claim 1, wherein the encapsulant material is a polymer.

5. The composite structure of claim 4, wherein the polymer is selected from the group consisting of polyethylene, polypropylene, polyethylene terephthalate, acrylic polymer gels, and polyurethane.

6. The composite structure of claim 1 further comprising an external coating providing protection to the structure.

7. The composite structure of claim 1 wherein the structure is a relatively rigid panel providing heat storage capability.

8. A composite structure comprising:
a phase change material;
an adsorbent material; and
an encapsulant material which encapsulates a mixture of phase change material and adsorbent material and provides rigidity to the composite structure.

9. The composite structure of claim 8, wherein the phase change material is selected from the group consisting of derivatives of fatty acids and paraffin, polyethylene glycols, salts and salt hydrates.

10. The composite structure of claim 8, wherein the adsorbent material is selected from the group consisting of activated carbon, diatomaceous earth powder, cellulose, fibers, foams, meshes, silica, cellite, gypsum, zeolite, cork, wood pulp, and graphite.

11. The composite structure of claim 8, wherein the encapsulant material is a polymer.

12. The composite structure of claim 11, wherein the polymer is selected from the group consisting of polyethylene, polypropylene, polyethylene terephthalate, acrylic polymer gels, and polyurethane.

13. The composite structure of claim 8 further comprising an external coating providing protection to the structure.

14. A method of manufacturing a composite structure comprising:
mixing a phase change material with an adsorbent material;
combining the mixture of phase change material and adsorbent material with an encapsulant material; and
forming the combined phase change material and adsorbent and encapsulant material into a desired shape.

15. The method of claim 14 wherein said combining the mixture of phase change material and adsorbent material with the encapsulant material includes mixing the phase change material and adsorbent material together first and then mixing in the encapsulant material to yield a combined mixture.

16. The method of claim 15 wherein the combined mixture is pressed or molded into the desired shape.

17. The method of claim 14 further comprising:
applying a coating on external surfaces of the desired shape.

18. The method of claim 17 wherein the coating prevents the phase change material from exiting the composite structure.

19. The method of claim 17 wherein the coating provides UV protection or thermal conductivity enhancement or flame retardancy.

20. The method of claim 14 wherein the phase change material is selected from the group consisting of derivatives of fatty acids and paraffin, polyethylene glycols, salts and salt hydrates, and the adsorbent material is selected from the group consisting of activated carbon, diatomaceous earth powder, cellulose, fibers, foams, meshes, silica, cellite, gypsum, zeolite, cork, wood pulp, and graphite, and the encapsulant material is selected from the group consisting of polyethylene, polypropylene, polyethylene terephthalate, acrylic polymer gels, and polyurethane.
